(19) United States
(12) Patent Application Publication
(10) Pub. No.: US 2024/0378447 A1
(43) Pub. Date: Nov. 14, 2024

(54) ENSEMBLE LEARNING ENHANCED PROMPTING FOR OPEN RELATION EXTRACTION

(71) Applicant: NEC Laboratories America, Inc., Princeton, NJ (US)

(72) Inventors: Xujiang Zhao, Hillsborough, NJ (US); Haifeng Chen, West Windsor, NJ (US); Wei Cheng, Princeton Junction, NJ (US); Yanchi Liu, Monmouth Junction, NJ (US)

(21) Appl. No.: 18/650,289

(22) Filed: Apr. 30, 2024

Related U.S. Application Data
(60) Provisional application No. 63/500,660, filed on May 8, 2023.

(51) Int. Cl. G06N 3/09; G06F 40/205

(52) U.S. Cl. CPC G06N 3/09; G06F 40/205

(57) ABSTRACT

Systems and methods are provided for extracting relations from text data, including collecting labeled text data from diverse sources, including digital archives and online repositories, each source including sentences annotated with detailed grammatical structures. Initial relational data is generated from the grammatical structures by applying advanced parsing and machine learning techniques using a sophisticated rule-based algorithm. Training sets are generated for enhancing the diversity and complexity of a relation dataset by applying data augmentation techniques to the initial relational data. A neural network model is trained using an array of semantically equivalent but syntactically varied prompt templates designed to test and refine linguistic capabilities of a model. A final relation extraction output is determined by implementing a vote-based decision system integrating statistical analysis and utilizing a weighted voting mechanism to optimize extraction accuracy and reliability.

### RELATED APPLICATION INFORMATION

This application claims priority to U.S. Provisional App. No. 63/500,660, filed on May 8, 2023, incorporated herein by reference in its entirety.

### BACKGROUND

### Technical Field

The present invention relates to enhancements in natural language processing and data analysis technologies, and more particularly to an advanced system and method for extracting and utilizing relationships from text data by applying ensemble learning enhanced prompting techniques to improve accuracy and efficiency of relational data extraction across diverse content.

### Description of the Related Art

In the realm of natural language processing (NLP) and data extraction, traditional approaches have focused on utilizing syntactic parsing and keyword matching techniques to extract useful information from text data. These methods rely on direct textual similarity and predefined linguistic rules to identify relationships within sentences, limiting their ability to adapt to the nuanced understanding required for complex relational data interpretation. Conventional systems struggle with accurately extracting and utilizing relationships in scenarios where context and semantic subtleties play a central role, such as in semantic search engines, personalized content recommendations, and sophisticated data analytics platforms. Moreover, the dependence on comparatively large, annotated datasets for training these conventional systems poses additional challenges, including substantial resource investment for manual annotation and the difficulty in scaling across diverse domains or languages. This highlights a pressing need for more advanced solutions capable of extracting meaningful relationships from text using minimal supervised examples and enhancing the adaptability and accuracy of relation extraction techniques, particularly in dynamically changing content landscapes.

### SUMMARY

According to an aspect of the present invention, a method is provided for extracting relations from text data, including collecting labeled text data from diverse sources, including digital archives and online repositories, each source including sentences annotated with detailed grammatical structures. Initial relational data is generated from the grammatical structures by applying advanced parsing and machine learning techniques using a sophisticated rule-based algorithm. Training sets are generated for enhancing the diversity and complexity of a relation dataset by applying data augmentation techniques to the initial relational data. A neural network model is trained using an array of semantically equivalent but syntactically varied prompt templates designed to test and refine linguistic capabilities of a model. A final relation extraction output is determined by implementing a vote-based decision system integrating statistical analysis and utilizing a weighted voting mechanism to optimize extraction accuracy and reliability.

According to another aspect of the present invention, a system is provided for extracting relations from text data, including a processor device and a memory storing instructions that when executed by the processor device, cause the system to collect labeled text data from diverse sources, including digital archives and online repositories, each including sentences annotated with detailed grammatical structures, systematically generate initial relational data from the grammatical structures by applying advanced parsing and machine learning techniques using a sophisticated rule-based algorithm, and generate training sets for enhancing the diversity and complexity of a relation dataset by applying any of a plurality of data augmentation techniques to the initial relational data. A neural network model is trained using an array of semantically equivalent but syntactically varied prompt templates designed to test and refine linguistic capabilities of a model. A final relation extraction output is determined by implementing a vote-based decision system integrating statistical analysis and utilizing a weighted voting mechanism to optimize extraction accuracy and reliability.

According to another aspect of the present invention, a computer program product is provided for extracting relations from text data, including collecting labeled text data from diverse sources, including digital archives and online repositories, each source including sentences annotated with detailed grammatical structures. Initial relational data is generated from the grammatical structures by applying advanced parsing and machine learning techniques using a sophisticated rule-based algorithm. Training sets are generated for enhancing the diversity and complexity of a relation dataset by applying data augmentation techniques to the initial relational data. A neural network model is trained using an array of semantically equivalent but syntactically varied prompt templates designed to test and refine linguistic capabilities of a model. A final relation extraction output is determined by implementing a vote-based decision system integrating statistical analysis and utilizing a weighted voting mechanism to optimize extraction accuracy and reliability.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustratively depicting an exemplary processing system to which the present invention may be applied, in accordance with embodiments of the present invention;

FIG. 2 is a diagram illustratively depicting a high-level view of an exemplary method for enhanced relational data extraction and analysis from text sources using Ensemble Learning Enhanced Prompting (ELEP), in accordance with embodiments of the present invention;

FIG. 3 is a diagram illustratively depicting a method for enhanced search engine functionality by processing input data based on semantic relationships using Ensemble Learning Enhanced Prompting (ELEP), in accordance with embodiments of the present invention;

FIG. 4 is a diagram illustratively depicting a system and method enhanced data extraction and relation identification across various applications via a networked environment using Ensemble Learning Enhanced Prompting (ELEP), in accordance with embodiments of the present invention;

FIG. 5 is a diagram illustratively depicting a method for advanced extracting and applying relational data from text sources using Ensemble Learning Enhanced Prompting (ELEP), in accordance with embodiments of the present invention; and

FIG. 6 is a diagram illustratively depicting a system for enhanced relational data extraction and analysis from text sources using Ensemble Learning Enhanced Prompting (ELEP), in accordance with embodiments of the present invention.

### DETAILED DESCRIPTION

In accordance with embodiments of the present invention, systems and methods are provided for improving open relation extraction from text data using Ensemble Learning Enhanced Prompting (ELEP). The invention can systematically process text data to extract relevant relational information (e.g., subject, action, object relationships, etc.) within sentences. At its core, the present invention can integrate an advanced rule-based algorithm coupled with machine learning techniques to generate and augment relational datasets. By leveraging ensemble learning and prompt ensembling, the present invention can train on a diverse set of prompt templates, enabling it to accurately and efficiently handle complex linguistic variations and enhance the accuracy of relation extraction. This capability can be effectively utilized for applications requiring nuanced text interpretation (e.g., semantic search engines, personalized content delivery, sophisticated data analytics platforms, etc.), in accordance with aspects of the present invention.

In some embodiments, the present invention can include a vote-based decision system to aggregate predictions from multiple model configurations, reducing variance and increasing the reliability of the outputs. This enables the system to adapt to new data with minimal retraining, optimizing operational efficiency. Additionally, the system can be integrated seamlessly into various real-world systems (e.g., enterprise data management systems), enhancing functionalities including search accuracy and content recommendations, thereby improving data utilization and operational efficiency across various business sectors. The system's architecture supports extensive scalability and flexibility, enabling effective handling of comparatively large-scale text datasets. Through continuous learning and adaptation, the invention can evolve over time, ensuring that it remains effective in changing technological landscapes, thereby meeting the demands of modern data-driven industries.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Aspects of the present invention are described below with reference to flowchart illustrations and/or block diagrams of methods, systems, and computer program products according to embodiments of the present invention. It is noted that each block of the flowcharts and/or block diagrams, and combinations of blocks in the flowcharts and/or block diagrams, may be implemented by computer program instructions.

The flowchart and block diagrams in the figures illustrate the architecture, functionality, and operation of possible implementations of systems, methods, and computer program products according to various embodiments of the present invention. Each block in the flowchart or block diagrams may represent a module, segment, or portion of code, which comprises one or more executable instructions for implementing the specified logical function(s), and in some alternative implementations of the present invention, the functions noted in the block may occur out of the order noted in the figures. For example, two blocks shown in succession may, in fact, be executed substantially concurrently, may sometimes be executed in reverse order, or may be executed in any other order, depending on the functionality of a particular embodiment.

It is also noted that each block of the block diagrams and/or flowchart illustration, and combinations of blocks in the block diagrams and/or flowchart illustration, can be implemented by specific purpose hardware systems that perform the specific functions/acts, or combinations of special purpose hardware and computer instructions according to the present principles.

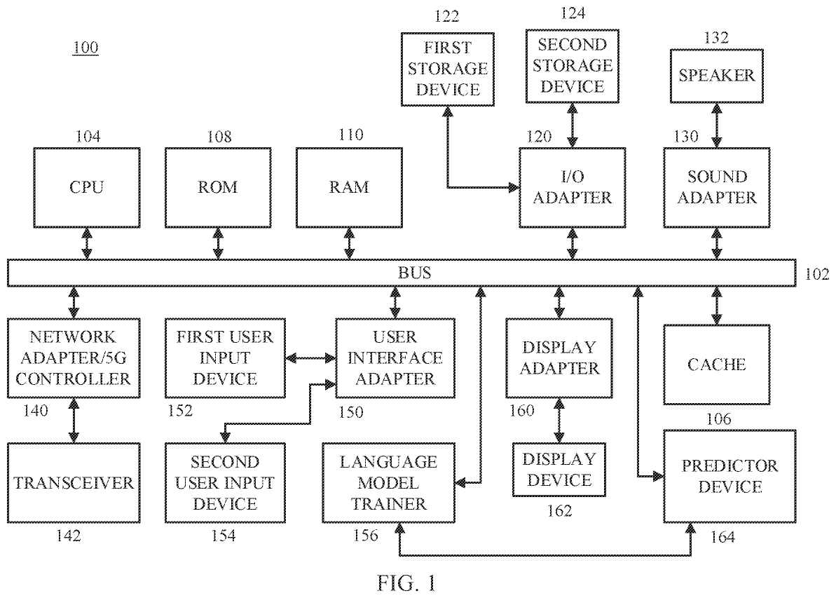

Referring now to the drawings in which like numerals represent the same or similar elements and initially to FIG. 1, an exemplary processing system 100, to which the present principles may be applied, is illustratively depicted in accordance with embodiments of the present principles.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. A Vision Language (VL) model can be utilized in conjunction with a predictor device 164 for input text processing tasks, and can be further coupled to system bus 102 by any appropriate connection system or method (e.g., Wi-Fi, wired, network adapter, etc.), in accordance with aspects of the present invention.

A first user input device 152 and a second user input device 154 are operatively coupled to system bus 102 by user interface adapter 150. The user input devices 152, 154 can be one or more of any of a keyboard, a mouse, a keypad, an image capture device, a motion sensing device, a microphone, a device incorporating the functionality of at least two of the preceding devices, and so forth. The language model trainer 156 can be included in a system with one or more storage devices, communication/networking devices (e.g., WiFi, 4G, 5G, Wired connectivity), hardware processors, etc., in accordance with aspects of the present invention. In various embodiments, other types of input devices can also be used, while maintaining the spirit of the present principles. The user input devices 152, 154 can be the same type of user input device or different types of user input devices. The user input devices 152, 154 are used to input and output information to and from system 100, in accordance with aspects of the present invention. A language model trainer 156 can process received input (e.g., via iterative neural network training), and a predictor device 164 can be operatively connected to the system 100 for vote-based prediction tasks, in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

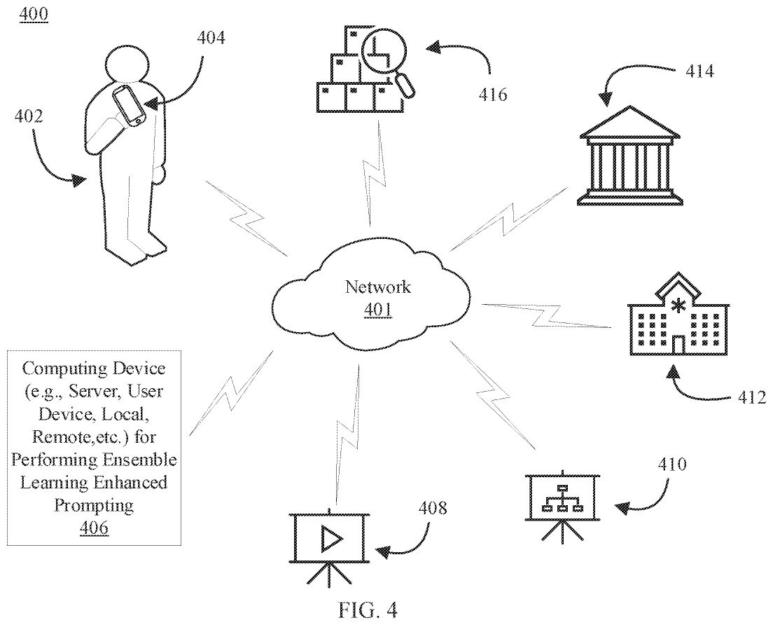

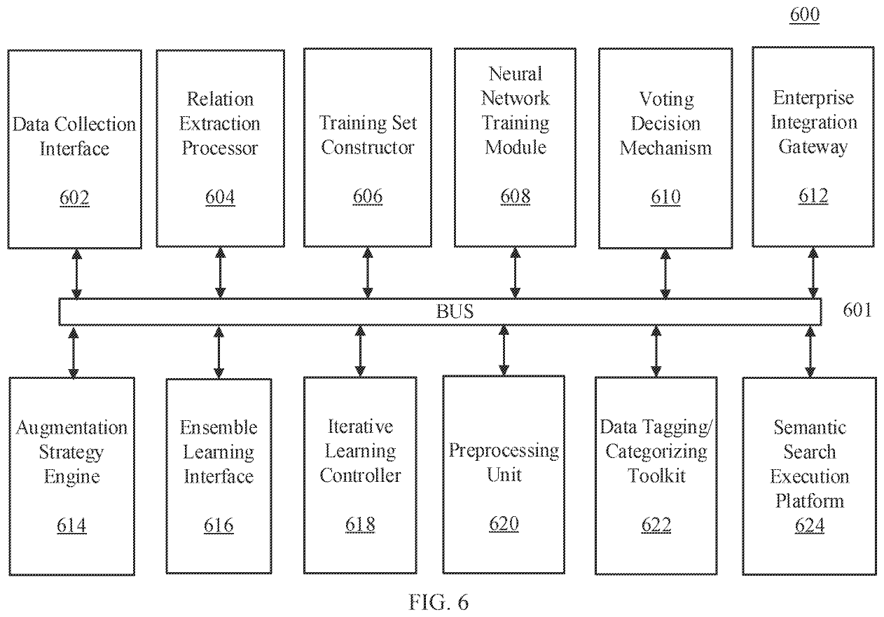

Moreover, it is to be appreciated that systems 400 and 600, described below with respect to FIGS. 4 and 6, respectively, are systems for implementing respective embodiments of the present invention. Part or all of processing system 100 may be implemented in one or more of the elements of systems 400 and 600, in accordance with aspects of the present invention.

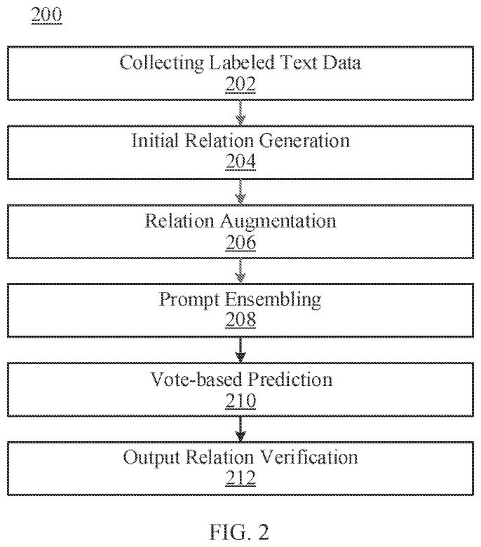

Further, it is to be appreciated that processing system 100 may perform at least part of the methods described herein including, for example, at least part of methods 200, 300, 400, and 500, described below with respect to FIGS. 2, 3, 4, and 5, respectively. Similarly, part or all of systems 400 and 600 may be used to perform at least part of methods 200, 300, 400, and 500 of FIGS. 2, 3, 4, and 5, respectively, in accordance with aspects of the present invention.

As employed herein, the term “hardware processor subsystem,” “processor,” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Referring now to FIG. 2, a high-level view of a method 200 for enhanced relational data extraction and analysis from text sources using Ensemble Learning Enhanced Prompting (ELEP), is illustratively depicted in accordance with embodiments of the present invention.

In various embodiments, in block 202, labeled text data can be collected, which may include a variety of sentences with their basic grammatical structures. This collection can cover diverse domains and textual formats, potentially including structured databases, free-form text from documents, or web-based sources. The data can be preprocessed to standardize format and content, ensuring consistency across the dataset. Techniques such as tokenization, part-of-speech tagging, and syntactic parsing may be utilized to annotate the text with grammatical information, thereby facilitating the extraction and classification of initial relational data based on predefined linguistic rules. This step can help to ensure that subsequent processes in the method, such as relation augmentation and prompt ensembling, are based on reliable and accurately parsed data. In various embodiments, to address the specific-domain open relation extraction problem on text data, a novel Ensemble Learning Enhanced Prompting (ELEP) framework can be employed to utilize implicitly stored knowledge in pretrained comparatively large language models to extract relevant open relations and filter the noise relations, in contrast to conventional methods that need direct supervision of a comparatively large portion of training.

In block 204, initial relations can be generated using a rule-based method, employing algorithms designed to analyze and interpret the grammatical structures of the collected text. This can involve the identification of potential relational pairs, such as subjects linked to verbs and objects, by applying grammatical rules that define valid syntactic constructions for different types of relationships. The algorithms can be adapted to handle variations in language use, such as passive voice, complex compound sentences, or idiomatic expressions, ensuring comprehensive coverage and accuracy in relation identification. This flexibility can enhance the model's ability to generalize across different linguistic contexts and domains, increasing the effectiveness of the relation extraction process.

In block 206, relation augmentation can be performed to significantly expand and diversify the training dataset. This may include generating synthetic examples by altering existing sentences to create new relational contexts, or by introducing adversarial examples that challenge the model's assumptions and biases. Techniques such as paraphrasing, negation, and semantic modification can be employed to create a wide range of positive and negative training instances. This process can help in improving the model's resilience against errors and its ability to accurately generalize from the training data to unseen data, thereby enhancing the overall robustness of the extraction process. Block 206 can include utilizing a rule-based algorithm to generate all possible relations base on the basic grammatical structure. Based on the potential relations pool, training examples can be built, and a diversity of negative relation examples can be enlarged via augmentation technical to further improve the training process.

In some embodiments, in block 206, a training set can be built and a relation augmentation can be applied. In this illustrative example, a rule-based method to generate all possible relations base on the basic grammatical structure can be employed. For the training examples x, it includes the original sentence S={s₁, s₂, . . . , s_{N}} and basic grammatical structure Y={y₁, y₂, . . . , y_{N}}, where yₙ={(o₁, o₂, . . . , oₘ)} is the sequential label for the sentence, and oₘ∈{s, a, b} represents one specific label of token m, and we only consider s=subject, a=action, b=object in this exemplary problem setting. Based on yₙ, all subjects, actions, and objects can be obtained, and an exhaustive rule or rules can be applied to find all combinations for potential relations pool R={r₁, r₂, . . . , rₖ} for each subject, action, and objects.

Based on the potential relations pool, training examples can be built, and the diversity of negative relation examples can be enlarged via augmentation techniques to further improve the training process. For example, given a sentence p and its positive relation, rₚ=(s, a, b), we can first create a negative relation rₙ₁=(b, a, s); randomly select one token w from sentence p, where w≠s, then we create a negative relation rₙ₂=(w, a, b); randomly select one token w from sentence p, where w≠a, then we create a negative relation rₙ₃=(s, w, b); randomly select one token w from sentence p, where w≠b, then we create a negative relation rₙ₄=(s, a, bw); and randomly select three tokens w, t, h from sentence p, where w≠{s, a, b}, t≠{s, a, b}, h≠{s, a, b}. Next, a negative relation rₙ₅=(w, t, h) can be created, and the diversity of negative relation examples can be enlarged by rₙ={rₙ₁, rₙ₂, rₙ₃, rₙ₄, rₙ₅}, in accordance with aspects of the present invention.

In block 208, multiple prompt templates that convey equivalent meanings can be crafted to train the model by prompt ensembling. This ensembling approach can involve the creation of prompts that vary not only in wording but also in structural complexity, to challenge and refine the model's capabilities. Each prompt can be tested against a subset of the training data to gauge its effectiveness in eliciting the correct model response. By employing a diverse set of prompts, the model can be trained to maintain high accuracy and consistency in relation extraction across a variety of linguistic formulations and contextual scenarios. This strategy can significantly reduce the potential for model overfitting to specific linguistic patterns or prompt formats. To prevent the overfitting for one specific prompt training, some same meaning prompt templates can be created and the model training can be performed utilizing these different prompt templates.

In some embodiments, prompt ensembling can reduce or prevent the overfitting for one (or more) specific prompt training, and can include creating some same meaning prompt templates and training the model by these different prompt templates. In an illustrative example, a question-answer prompt can be generated and/or presented to verify the relation of the original sentence, denotes as Promptₒ(p, r:θ):
“{Original sentence p}” Question: In this sentence, “{subject-action-object} r”? Is it correct? <mask>,
   where <mask> is the prediction part of pretrain language mode (PLM) based on the prompt, noting that in this example we design the answer space as <[No], [Yes]>, where “No” represent the relation is not make sense, and “Yes” represent the relation is make sense. The prompt can include the parameters θ for a binary classifier:

PLM(Promptₒ(p,r:θ))=t,

where t∈{0, 1} is the pretrain language model's prediction.

In some embodiments, additional different prompt templates (e.g., in this illustrative example, three (3) additional different prompt templates are shown for ease of illustration, noting that any number of templates can be utilized):
Promptᵤ(p, r:θ): “{Original sentence p}” Question: In this sentence, “{subject-action-object} r”? Is it correct?<[No, Maybe], [Yes]>
Prompt, (p, r′:θ): “{Original sentence p}” Question: In this sentence, “{object-action-subject} r′”? Is it correct?<[No], [Yes]>
Promptᵣᵤ(p, r′:θ): “{Original sentence p}” Question: In this sentence, “{object-action-subject} r′”? Is it correct?<[No, Maybe], [Yes]>,
   where r′ is the reverse relation: object-action-subject. In various embodiments, after training, at the inference stage, given a test relation, we have K different prediction, P1, P2 . . . , PK. 2. Based P1, P2 . . . , PK, we consider a vote strategy to get the final prediction. If any prediction among P1, . . . , PK is negative, final prediction=negative. (e.g., since PRE model can have too many false positive predictions), in accordance with aspects of the present invention.

In block 210, a vote-based prediction system can be implemented to consolidate and finalize the outputs from the different prompts used in training the model. This system can aggregate predictions to apply a consensus-based approach, where the final output is determined by a majority vote or other statistical methods that consider the confidence levels associated with each prediction. Such an approach can be particularly effective in minimizing the impact of outliers or anomalous model responses, thereby ensuring that the final relation extraction results are both reliable and representative of the collective intelligence of the various trained models.

In an exemplary embodiment, in block 210, after the relation augmentation and prompt ensembling, the framework of the present invention can retrain a pretrained language model with prompts with few shots examples based on the relation augmentation and prompt ensembling. Then a final prediction can be determined based on all different prompt predictions:

PLM(Promptₒ(p,r:θ₁))=t₁

PLM(Promptᵤ(p,r:θ₂))=t₂

PLM(Promptᵣ(p,r:θ₃))=t₃

PLM(Promptᵣᵤ(p,r:θ₄))=t₄

where θ₁, θ₂, θ₃, θ₄ are the prompt parameters utilized the framework to train, and t₁, t₂, t₃, t₄ are the different predictions of prompt ensembling. Then, a vote strategy can be utilized to generate the final prediction. If any prediction among t₁, t₂, t₃, t₄ is negative, final prediction t_{f}=negative. This vote strategy is able help to reduce more false positive predictions, in accordance with aspects of the present invention.

In block 212, the extracted relations can be verified against the input sentences to ensure they accurately reflect the intended meanings and adhere to the grammatical structures presented. Verification can include both automated and manual reviews, where outputs are systematically checked for logical consistency, relevance to the input context, and adherence to expected grammatical norms. This step can also involve iterative refinement processes, where feedback from the verification stage is used to further train and optimize the model, ensuring that the end results meet high standards of accuracy and applicability, in accordance with aspects of the present invention.

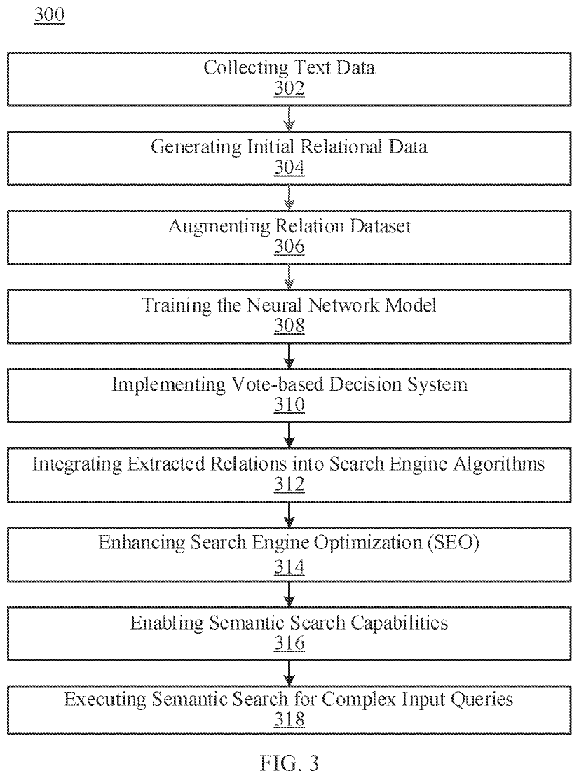

Referring now to FIG. 3, a diagram showing a method 300 for enhanced search engine functionality by processing input data based on semantic relationships using Ensemble Learning Enhanced Prompting (ELEP), is illustratively depicted in accordance with embodiments of the present invention.

In various embodiments, in block 302, extensive text data can be collected from a diverse range of online sources, including digital archives, scholarly databases, news portals, and social media platforms. This data collection process can be designed to encompass a wide variety of content types, each annotated with comprehensive grammatical structures to facilitate detailed linguistic analysis. Automated data scraping tools equipped with advanced filtering algorithms can be employed to ensure the data is relevant and of high quality, focusing on documents that provide rich linguistic constructs necessary for effective relation extraction.

In block 304, initial relational data can be systematically generated by applying state-of-the-art parsing and machine learning techniques embedded within a sophisticated rule-based algorithm. This algorithm can utilize natural language processing (NLP) frameworks to dissect complex sentence structures, identifying key grammatical dependencies and semantic relationships such as subject-action-object tuples. The process can be augmented by machine learning models trained to infer contextual relationships that are not explicitly expressed, enhancing the depth and accuracy of the relational analysis.

In block 306, the initially generated relational dataset can be significantly enhanced by employing a variety of data augmentation techniques. These techniques can include synthetic example generation, which involves artificially creating new data points that mimic real-world textual variations, and adversarial input creation, which introduces deliberately challenging or misleading examples to improve the model's robustness. Additionally, semantic perturbation can be applied to subtly alter the meaning of texts to test and strengthen the model's ability to maintain accuracy under varied semantic conditions.

In block 308, a neural network model can be trained using a comprehensive array of prompt templates, which are semantically equivalent but syntactically varied. This training can involve multiple cycles of evaluation and adjustment to optimize the model's performance across different linguistic scenarios. The model can learn to predict relational structures with high accuracy, refining its responses based on feedback from performance metrics such as precision, recall, and the F1 score. In block 310, a vote-based decision system can be implemented to determine the most accurate relation extraction outputs. This system can use a weighted voting mechanism where each vote is assigned based on the confidence score of the model's prediction, thereby prioritizing more reliable outputs in the final decision-making process.

In block 312, the extracted relations can be integrated into the search engine's algorithms to enhance the indexing and retrieval processes. This integration can enable the search engine to better comprehend the contextual and semantic relationships between terms in user queries and the indexed content, potentially leading to more relevant and accurate search results. In block 314, search engine optimization (SEO) techniques can be enhanced by utilizing the extracted relational data. This enhancement can enable more precise keyword targeting, improved content relevancy for specific queries, and better alignment of search results with user intent.

In block 316, semantic search capabilities can be enabled within the search engine, allowing it to process and respond to complex queries based on the understanding of deep semantic relationships within the data. This functionality can allow the search engine to handle nuanced inquiries that require an understanding of context and relational meaning, offering users search results that are more aligned with their informational needs. In block 318, the semantic search capabilities described in block 316 can be actively utilized to execute searches for complex input queries. This involves the search engine processing and interpreting queries that go beyond simple keyword searches to include those that require an understanding of the deeper semantic relationships and contexts embedded within the text. For example, the system can handle queries such as “economic impacts of climate change on agriculture in Southeast Asia,” where it uses the extracted relations to understand and pull together information that spans multiple contextually related concepts. This functionality enables the search engine to deliver highly relevant and contextually rich search results tailored to the specific nuances and complexities of user inquiries, thereby significantly enhancing user experience and satisfaction, in accordance with aspects of the present invention.

Referring now to FIG. 4, a diagram showing a system and method 400 for enhanced data extraction and relation identification across various applications via a networked environment using Ensemble Learning Enhanced Prompting (ELEP), is illustratively depicted in accordance with embodiments of the present invention.

In various embodiments, a user 402 can interact with the system to initiate queries and receive information. This user can be an individual engaging with any number of applications that benefit from enhanced relational data extraction, including, for example, performing detailed search queries, requesting business analytics, seeking healthcare data insights, legal analysis, etc., in accordance with aspects of the present invention. In block 404, a user device can be utilized for entering queries by user 402. This device can range from personal computers to mobile devices and is equipped with software capable of formatting and transmitting the user's query to the system over a network for processing. Network 401 can be a communication network that serves as the infrastructure for transmitting data and queries between the user, the system, and various data endpoints. This network can be the internet, a private network, or a combination thereof, facilitating the flow of information securely and efficiently.

Block 406 represents a computing device (e.g., server, personal computer, laptop, etc.) for performing Ensemble Learning Enhanced Prompting. This device may operate as a server or a collection of cloud-based resources that process input data, a local machine, etc., and can execute relation extraction models and apply ensemble learning techniques to generate refined outputs based on user queries.

In block 408, representing streaming services, the Intelligent Recommendation System can utilize relation extraction outputs to enhance content personalization and provide context-aware recommendations. This system can analyze user interaction data alongside content descriptions to tailor suggestions that align closely with individual user preferences. Platforms like Netflix®, Spotify®, or Amazon® can utilize the described method to analyze user behavior and content descriptions systematically. By extracting relationships and preferences from user interaction data (e.g., what they watch, purchase, rate, etc.), the system can refine its algorithms to suggest content or products that more closely match individual user profiles. This personalization is driven by a deep understanding of user preferences, behavioral patterns, and content relationships, enhancing user engagement and satisfaction. The capability to parse and understand complex relationships in user data aids recommendation systems in delivering suggestions that align with users' specific interests and past interactions. For instance, if a user frequently watches mystery genres with strong female leads, the system might recommend new or less-known shows with similar themes but different settings, thereby diversifying the user's experience while keeping it within the bounds of their interests.

Block 410 can include an Advanced Business Analytics Interface that applies the extracted relational data to conduct market trend analysis and competitor analysis. It can systematically process diverse business intelligence data to provide insights that support strategic business decisions. Companies can apply the method to various data sources like market research reports, social media content, and financial news to extract and analyze relationships between market drivers, customer sentiment, and product performance. This analysis helps in identifying trends, predicting market movements, and understanding consumer behavior, which in turn supports more informed and strategic business decisions. By systematically gathering and analyzing information about competitors, businesses can discover relationships between different market activities and strategies employed by their competitors. This method allows for a structured analysis of competitor strengths and weaknesses, marketing strategies, and customer engagement tactics, enabling companies to position themselves more strategically within the market.

Block 412, symbolized by a hospital building, represents a Healthcare Data Management System. This system can implement the described methods to analyze patient records and clinical data, extracting complex relationships that inform patient care, treatment plans, and personalized medicine practices. Hospitals and healthcare providers can implement the method to analyze patient records, clinical studies, and research papers to extract and understand complex relationships, such as those between symptoms, diagnoses, treatments, and patient outcomes. This analysis supports more accurate diagnoses, improves treatment plans, and contributes to more personalized patient care. Understanding the relationships between different biological markers and patient histories allows healthcare providers to tailor treatments to individual patients. This approach enhances treatment effectiveness and optimizes healthcare outcomes by considering unique genetic, environmental, and lifestyle factors that influence health conditions.

Block 414, depicted as a law firm or court building, can be a Legal Document Analysis System. It can leverage the relational data extraction technology to analyze legal documents, assisting in case law research, contract analysis, and overall legal strategy formulation. Law firms and legal departments can use the method to analyze large volumes of legal documents, extracting relationships between case facts, precedents, and legal outcomes. This assists in case preparation, strategy formulation, and understanding judicial trends, making legal practice more efficient and informed. Automated extraction of key obligations, rights, and conditions from contracts and other legal documents improves compliance monitoring and risk management. By identifying and understanding the relationships and stipulations within contracts, organizations can better manage their legal obligations and reduce potential legal risks.

Block 416, symbolizing Enhanced Search Engines, can apply the methods described to go beyond traditional keyword searches. By understanding the intent and contextual meaning of user queries, this engine can handle complex searches and improve the relevance and accuracy of search results. By implementing the present invention, search engines can enhance their understanding of the relationships between different terms and concepts within the content they index. This can lead to more accurate search results, improved relevance of retrieved documents, and a more intuitive search experience for users. The method can enable search engines to go beyond keyword matching, allowing them to understand the intent and contextual meaning of user queries. This can make it possible to handle complex queries that depend on understanding relationships between entities, such as “What are the key impacts of climate change on coastal areas?”. Each of the above-described exemplary applications demonstrates the versatility and wide-ranging impact of the core technology of the present invention of extracting relationships from text data, tailored to solve specific problems or enhance efficiency across various industries, in accordance with aspects of the present invention.

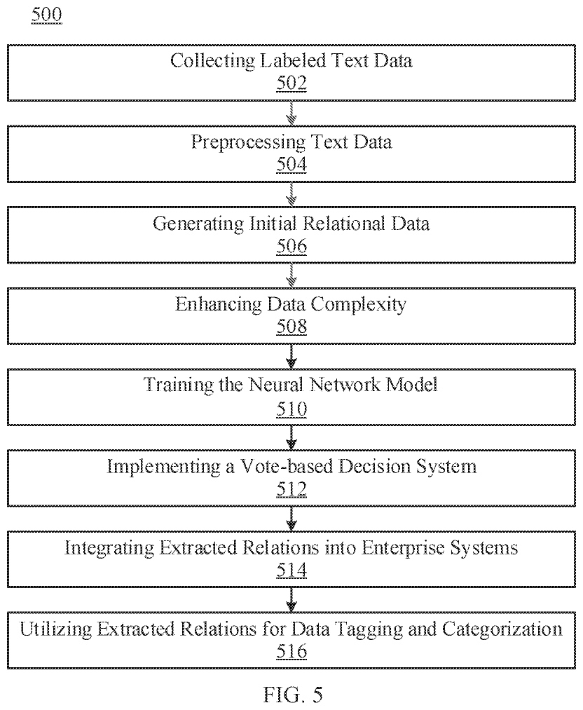

Referring now to FIG. 5, a diagram showing a method 500 for advanced extracting and applying relational data from text sources using Ensemble Learning Enhanced Prompting (ELEP), is illustratively depicted in accordance with embodiments of the present invention.

In various embodiments, in block 502, extensive text data can be collected from diverse sources, including digital archives, online repositories, and specialized databases. Each source comprises sentences annotated with detailed grammatical structures. The collection process can include utilizing sophisticated web scraping technologies and APIs that access and retrieve text data while ensuring that the data includes necessary linguistic annotations to facilitate further processing. In block 504, preprocessing operations can be applied to the collected text data to remove noise and standardize formats across different sources. This can include normalization techniques such as converting all text to a uniform character encoding, correcting typos, and standardizing date formats and other entities. This step ensures that the data input into the system is clean, consistent, and primed for accurate analysis.

In block 506, initial relational data can be generated from the grammatical structures by applying advanced parsing techniques and machine learning algorithms embedded within a sophisticated rule-based system. This can include deep linguistic analysis tools that can dissect complex sentence structures to extract entities and their relationships, such as subject-action-object tuples, which can be utilized for understanding the inherent semantics of the text. In block 508, the diversity and complexity of the relation dataset can be enhanced by applying various data augmentation techniques to the initial relational data. This can include generating synthetic examples that simulate real-world linguistic variations and creating adversarial examples designed to test and strengthen the resilience of the model against tricky inputs. Semantic perturbation techniques are also used to subtly alter the meanings in texts to ensure the model can handle semantic nuances effectively.

In block 510, a neural network model can be trained using an extensive array of semantically equivalent but syntactically varied prompt templates. The training process can include multiple iterations where adjustments are made based on performance metrics like accuracy and loss reduction. This iterative training and evaluation cycle helps refine the model's ability to accurately process and analyze complex relational data. In block 512, a vote-based decision system an be implemented to determine the final relation extraction output. This system can utilize a weighted voting mechanism that considers the confidence scores of individual model outputs to optimize extraction accuracy. The voting process helps mitigate potential biases or errors from any single model's prediction, ensuring the system's overall reliability and robustness.

In block 514, the extracted relations can be integrated into enterprise data management systems. This integration enhances functionalities such as search accuracy, content recommendation, and automated data retrieval within corporate databases and ERP systems. The process can include mapping extracted relations to specific data fields and employing algorithms that use these relations to facilitate more intelligent and context-aware data querying and manipulation. In block 516, the extracted relations can be used to automatically tag and categorize incoming text data in large-scale information systems. This application of the relations helps enhance data accessibility and retrievability by organizing data into coherent categories based on its content and context. This process can be particularly beneficial in environments where data volumes are comparatively large and dynamic, enabling automated systems to maintain order and accessibility, in accordance with aspects of the present invention.

Referring now to FIG. 6, a diagram showing a system 600 for enhanced relational data extraction and analysis from text sources using Ensemble Learning Enhanced Prompting (ELEP), is illustratively depicted in accordance with embodiments of the present invention.

In various embodiments, a data collection interface 602 can serve as an advanced gateway for aggregating text data from a multitude of sources, including but not limited to academic journals, web pages, proprietary databases, and publicly accessible digital repositories. This interface is equipped with sophisticated algorithms capable of discerning and extracting sentences annotated with complex grammatical structures. It can ensure that the collected data encompasses a wide spectrum of linguistic expressions and styles, catering to the needs of various analysis tasks that the system is designed to perform.

A relation extraction processor 604 can be utilized for systematically processing input data to identify intrinsic relational pairs, such as subjects connected to objects through verbs or actions, using a hybrid approach that combines rule-based algorithms with advanced machine learning techniques. It can be fine-tuned to discern subtle linguistic nuances and contextual cues that a standard parser might overlook, thereby significantly enhancing the quality and depth of the relational analysis. This processor is also capable of evolving through iterative learning, adjusting its algorithms to adapt to new forms of textual content as they emerge.

A training set constructor 606 can enrich the initially parsed relational data, transforming it into a comprehensive training set designed to prepare the neural network model for a wide range of predictive tasks. Through a sophisticated selection of data augmentation strategies, including the injection of synthetic variations and adversarial inputs, this constructor can create a dataset that thoroughly tests and enhances the neural network's resilience and its capacity to generalize from training to real-world data. A neural network (NN) training device 608 can form a learning core of the system, employing an extensive suite of semantically equivalent yet syntactically diverse prompt templates to conduct exhaustive training sessions. The NN training device 608 infrastructure is designed to accommodate high-throughput data processing, enabling rapid iteration and dynamic adjustment of training parameters. This can be utilized for refining the model's ability to accurately decode and interpret complex relational constructs across various domains and contexts.

A voting decision mechanism 610 can consolidate predictions from the neural network model, applying a weighted voting algorithm that factors in the confidence scores associated with each prediction. This sophisticated decision system can arbitrate between differing model outputs to derive a consensus, ensuring that the most probable and accurate relational interpretations are chosen. This voting decision mechanism 610 can be utilized for maintaining consistency and precision in the model's output, ensuring the integrity of downstream applications. An enterprise integration gateway 612 can operate as a conduit for funneling the processed relational data into enterprise systems, where it can be harnessed to enhance various functionalities. The gateway facilitates the integration of relational insights into search algorithms, recommendation engines, and data management frameworks, thereby augmenting the decision-making processes within various systems (e.g., corporate environments, Enterprise Resource Planning (ERP), law firm documents, hospital records, etc.). This seamless integration can lead to significant improvements in operational efficiency and data-driven intelligence.

An augmentation strategy engine 614 can orchestrate the data augmentation process. It leverages machine learning insights to intelligently balance the mix of synthetic and adversarial examples in the training set, thereby achieving an optimal configuration for model hardening. An ensemble learning interface 616 can integrate multiple predictive models through ensemble learning techniques. This interface enhances the system's decision-making capacity by pooling insights from a spectrum of trained models, thus mitigating the impact of any one model's bias or error. The resultant composite predictions are characterized by their robustness and represent a synthesized form of collective intelligence drawn from across the ensemble. An iterative learning controller 618 can administer the training regime of the neural network model, guiding it through cycles of learning and evaluation. This controller can carefully monitor performance indicators, orchestrating the fine-tuning of the model to enhance its predictive prowess, and the learning process can iteratively propel the model towards peak efficiency and accuracy.

A preprocessing unit 620 can be utilized for refining the collected text data through a series of preparatory steps aimed at ensuring the highest quality of input data. It can execute complex noise reduction algorithms, data cleansing routines, and format standardization protocols, establishing a uniform data input stream, which provides for the reliable performance of subsequent components in the system. A data tagging and categorization toolkit 622 can be leveraged to automate the organization of large volumes of text data. This toolkit can utilize the relations extracted by previous system components to systematically tag and categorize new incoming text data for enhanced accessibility. It can apply complex algorithms to sort and classify text according to themes, subjects, or other relevant criteria, facilitating efficient data retrieval and knowledge discovery. The toolkit may also interface with existing databases to enrich the metadata associated with stored content, ensuring that the vast stores of information are easily navigable and their value maximized.

A semantic search execution platform 624 can be utilized to actively execute semantic searches for complex input queries. This platform can harness the sophisticated neural network model and the processed relational data to interpret user queries that involve intricate semantic relationships. Capable of dissecting and understanding the context and nuance behind user inputs, the platform can generate search results that are not only relevant but also semantically aligned with user intent, providing a sophisticated and highly refined search experience. Together, these blocks represent a system 600, interconnected by communication bus 601, which facilitates the flow of data and instructions for the holistic functioning of the system. The architecture of the system 600 can be optimized to process, analyze, and apply relational data extracted from text, delivering high-precision capabilities across various use cases, from enterprise-level data management to advanced search engine functionality, in accordance with aspects of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for extracting relations from text data, comprising:
collecting labeled text data from diverse sources, including digital archives and online repositories, each source including sentences annotated with detailed grammatical structures;
systematically generating initial relational data from the grammatical structures by applying advanced parsing and machine learning techniques using a sophisticated rule-based algorithm;
generating training sets for enhancing the diversity and complexity of a relation dataset by applying any of a plurality of data augmentation techniques to the initial relational data;
training a neural network model using a comprehensive array of semantically equivalent but syntactically varied prompt templates designed to test and refine linguistic capabilities of a model;
determining a final relation extraction output by implementing a vote-based decision system integrating statistical analysis and utilizing a weighted voting mechanism to optimize extraction accuracy and reliability.

2. The method of claim 1, wherein the collecting of labeled text data includes preprocessing operations to remove noise and transform the data to standardize formats across different text sources.

3. The method of claim 1, further comprising integrating the extracted relations into enterprise data management systems to provide automated data retrieval and enhance functionalities including search accuracy and content recommendations within corporate databases and Enterprise Resource Planning (ERP) systems for improved operational efficiency and data utilization based on derived relational insights.

4. The method of claim 1, wherein the generation of training sets includes using machine learning models to automatically determine an optimal mix of synthetic and adversarial examples to achieve maximum model robustness against unseen data.

5. The method of claim 1, wherein training the neural network model further includes performing multiple iterations of training cycles, each followed by an evaluation phase where model adjustments are made based on performance metrics such as accuracy and loss reduction.

6. The method of claim 1, wherein determining the final relation extraction output includes applying ensemble learning techniques in which multiple model predictions are combined to reduce variance and improve decision accuracy.

7. The method of claim 1, further comprising integrating and utilizing the extracted relations to automatically tag and categorize new incoming text data to enhance data accessibility and retrievability in comparatively large-scale information systems.

8. A system for extracting relations from text data, comprising:
a processor device; and
a memory storing instructions that, when executed by the processor device, cause the system to:
collect labeled text data from diverse sources, including digital archives and online repositories, each including sentences annotated with detailed grammatical structures;
systematically generate initial relational data from the grammatical structures by applying advanced parsing and machine learning techniques using a sophisticated rule-based algorithm;
generate training sets for enhancing the diversity and complexity of a relation dataset by applying any of a plurality of data augmentation techniques to the initial relational data;
train a neural network model using a comprehensive array of semantically equivalent but syntactically varied prompt templates designed to test and refine linguistic capabilities of a model;
determine a final relation extraction output by implementing a vote-based decision system integrating statistical analysis and utilizing a weighted voting mechanism to optimize extraction accuracy and reliability.

9. The system of claim 8, wherein the collecting the labeled text data includes preprocessing operations to remove noise and transform the data to standardize formats across different text sources.

10. The system of claim 8, wherein the instructions further cause the system to integrate the extracted relations into enterprise data management systems to provide automated data retrieval and enhance functionalities including search accuracy and content recommendations within corporate databases and Enterprise Resource Planning (ERP) systems for improved operational efficiency and data utilization based on derived relational insights.

11. The system of claim 8, wherein the generating the training sets includes using machine learning models to automatically determine an optimal mix of synthetic and adversarial examples to achieve maximum model robustness against unseen data.

12. The system of claim 8, wherein the training the neural network model includes performing multiple iterations of training cycles, each followed by an evaluation phase where model adjustments are made based on performance metrics such as accuracy and loss reduction.

13. The system of claim 8, wherein the determining the final relation extraction output includes applying ensemble learning techniques in which multiple model predictions are combined to reduce variance and improve decision accuracy.

14. The system of claim 8, wherein the instructions further cause the system to integrate and utilize the extracted relations to automatically tag and categorize new incoming text data to enhance data accessibility and retrievability in comparatively large-scale information systems.

15. A computer program product for extracting relations from text data, the computer program product comprising a computer-readable storage medium having program instructions embodied therewith, the program instructions executable by a hardware processor to:
collect labeled text data from diverse sources, including digital archives and online repositories, each including sentences annotated with detailed grammatical structures;
systematically generate initial relational data from the grammatical structures by applying advanced parsing and machine learning techniques using a sophisticated rule-based algorithm;
generate training sets for enhancing the diversity and complexity of a relation dataset by applying any of a plurality of data augmentation techniques to the initial relational data;
train a neural network model using a comprehensive array of semantically equivalent but syntactically varied prompt templates designed to test and refine linguistic capabilities of a model; and
determine a final relation extraction output by implementing a vote-based decision system integrating statistical analysis and utilizing a weighted voting mechanism to optimize extraction accuracy and reliability.

16. The computer program product of claim 15, wherein the collecting the labeled text data includes preprocessing operations to remove noise and transform the data to standardize formats across different text sources.

17. The computer program product of claim 15, further comprising instructions for integrating the extracted relations into enterprise data management systems to provide automated data retrieval and enhance functionalities including search accuracy and content recommendations within corporate databases and Enterprise Resource Planning (ERP) systems for improved operational efficiency and data utilization based on derived relational insights.

18. The computer program product of claim 15, wherein the generating the training sets includes using machine learning models to automatically determine an optimal mix of synthetic and adversarial examples to achieve maximum model robustness against unseen data.

19. The computer program product of claim 15, wherein the training the neural network model includes performing multiple iterations of training cycles, each followed by an evaluation phase where model adjustments are made based on performance metrics such as accuracy and loss reduction.

20. The computer program product of claim 15, further comprising instructions for integrating and utilizing the extracted relations to automatically tag and categorize new incoming text data to enhance data accessibility and retrievability in comparatively large-scale information systems.
